(19) United States
(12) Patent Application Publication
(10) Pub. No.: US 2012/0085504 A1
(43) Pub. Date: Apr. 12, 2012

(54) BLIND OF UNITED BLIND BY WEAVING

(76) Inventor: Ki Cheol CHA, Daegu (KR)

(21) Appl. No.: 13/329,780

(22) Filed: Dec. 19, 2011

Related U.S. Application Data
(63) Continuation of application No. 12/091,149, filed on Apr. 22, 2008.

(30) Foreign Application Priority Data
Nov. 24, 2006 (KR) 10-2006-0117059

(51) Int. Cl. E06B 9/28; D06C 13/00; D03D 23/00; D03D 3/00

(52) U.S. Cl. 160/236; 139/384 A; 26/11.4

(57) ABSTRACT

The present invention provides a textile blind united by weaving, which is formed as a single body by weaving slat textiles along a width between a front textile and a back textile in parallel with each other, wherein the slat textiles are arranged along the height of the front and back textiles to make the textile blind easily block lights.

### TECHNICAL FIELD

The present invention relates to a textile blind united by weaving, and in particular, to a textile blind formed of yarns, wherein the textile blind has a front textile, a back textile, and a slat textile for blocking lights, and each of the textiles is united with a front uniting part and a back uniting part by weaving a woof.

### BACKGROUND ART

In general, curtains and blinds are installed on window or doorways of a building and are used for blocking solar light, external sight, noise and cold, and are also used as an important factor of indoor decoration for enhancing indoor beauty in accordance with combination of colors that can be harmonized with indoor walls or glasses.

The blind operates as follows. When a rope for pulling up or down the blind is pulled down, a reeling driver rotates in forward and backward directions, which leads to a forward and backward directional rotation of a reel pole so that a roll screen is rolled down from the reel pole or rolled up to adjust a degree of covering a window. However, such a method can not adjust an amount of lights flowing indoor at all while the blind is pulled down across the entire window.

To cope with such a problem, several kinds of Venetian blinds using a plate-shaped slat are disclosed for adjusting lighting, however, the conventional Venetian blind not only has a complicated structure for adjusting brightness but also has a very burdensome adjusting function and a high cost unit of manufacture.

Further, the Venetian blind is formed of metal or wood instead of a conventional synthetic resin due to an upgrade of the slat, which causes the blind to be much weighted so that it is difficult to install the blind.

In a case of a conventional textile blind 20 shown in FIG. 1 among such blinds as described above, a textile slat 23 is formed between a front side 21 and the back side 22 by means of thermal treatment, and an adhered part 24 bonded by the thermal treatment is fallen apart at this time when it is exposed to solar lights for a long period of time, so that the blind cannot properly act its own function.

### DISCLOSURE

### Technical Problem

The present invention is directed to a textile blind having a united structure by weaving for enhancing durability and coherence of the structure.

### Technical Solution

One aspect of the present invention is to provide a textile blind, which includes, a front textile, a back textile in parallel with the front textile, and a slat textile having a predetermined width along a width between the front and back textiles, wherein both ends of the slat textile are united with the respective front and back textiles by weaving to form respective front uniting and back uniting parts, a plurality of the slat textiles are arranged along a height of the front and back textiles, and the front uniting part of one slat textile has the same height as the back uniting part of an adjacent slat textile to simplify adjustment and structure of the textile blind.

A low melt fiber is used as the woof of the textile blind, and the textile blind is woven to be united and then heat is applied by a Tenter to allow the low melt fiber to be melt-bonded so that the textile structure of the textile blind can be maintained and durability of the same can be enhanced.

In addition, the woof of the textile blind is mixed with a rubber thread to prevent folds from occurring after manufacture of the textile blind.

Further, each of the front and back textiles has a mesh structure, and each mesh of one of the front and back textiles has a square shape and each mesh of the other of the front and back textiles has a shape with a ratio of 1 by 1.5 to 2.5 to prevent a moire phenomenon.

### Advantageous Effects

A textile blind of the present invention united by weaving and then is produced, so that it can be easily adjusted and installed by aid of its simplified structure and its total light weight.

A low melt fiber is used as the woof of the textile blind, and the textile blind is woven to be united and then heat is applied by a Tenter to allow the low melt fiber to be melt-bonded so that the textile structure of the textile blind can be maintained and durability of the same can be enhanced.

In addition, the woof of the textile blind is mixed with a rubber thread to prevent folds from occurring after manufacture of the textile blind.

Further, each of the front and back textiles has a mesh structure, and each mesh of one of the front and back textiles has a square shape, and each mesh of the other of the front and back textiles has a shape with a ratio of horizontal and vertical lengths different from each other, thereby preventing a moire phenomenon.

### DESCRIPTION OF DRAWINGS

FIG. 1 is a perspective diagram illustrating a blind made by a conventional method.

FIG. 2 is a perspective diagram illustrating a textile blind woven by a process of the present invention.

FIG. 3 is a perspective diagram illustrating a textile blind woven by a process of the present invention.

FIGS. 4 to 8 are diagrams illustrating work flow processes of a textile blind woven in accordance with the present invention.

FIGS. 7 to 9 are state diagrams illustrating usage of a textile blind woven in accordance with the present invention.

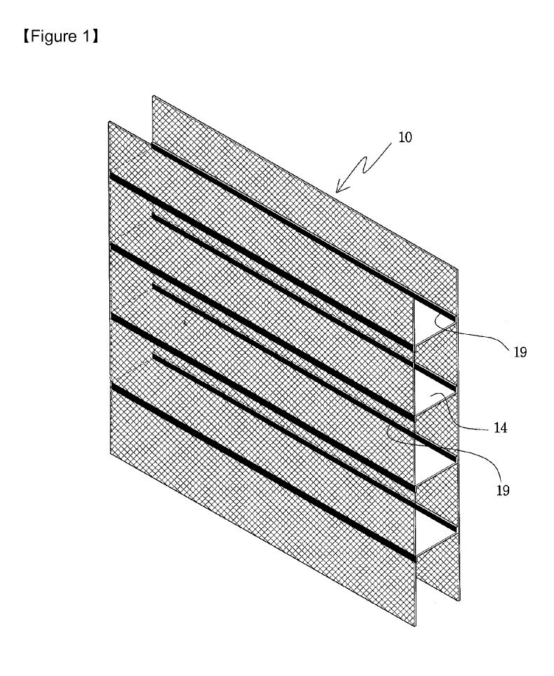

### BEST MODE

The present invention provides a textile blind united by weaving, which includes a front textile, a back textile in parallel with the front textile, and a slat textile having a predetermined width along a width between the front and back textiles, wherein both ends of the slat textile are united with the respective front and back textiles by weaving to form respective front uniting and back uniting parts, a plurality of the slat textiles are arranged along a height of the front and back textiles, and the front uniting part of one slat textile has the same height as the back uniting part of an adjacent slat textile, so that the textile blind configured as described above is applied to a typical blind structure to facilitate installment, adjustment, blocking solar lights and lighting.

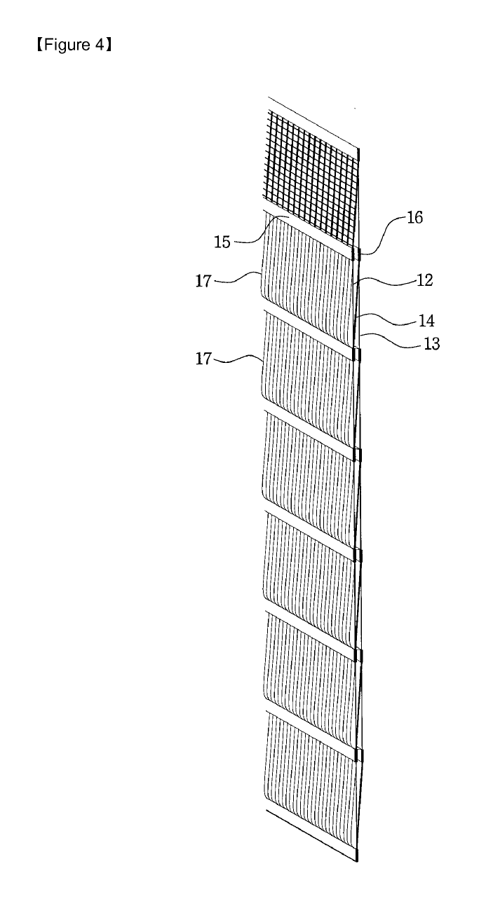

According to the textile blind 10 of the present invention, as shown in FIGS. 4 to 6, each warp 12a, 13a, 17 is woven by a separate woof to form the textile blind 10, which includes a front textile 12 and a back textile 13 for ventilation, and a slat textile 14 for blocking lights, and the slat textile 14 is united with the front textile 12 and the back textile 13 along both ends of its longitudinal direction to form respective front uniting part 15 and back uniting part 16. Such a textile blind 10 will now be described in detail with reference to accompanying drawings.

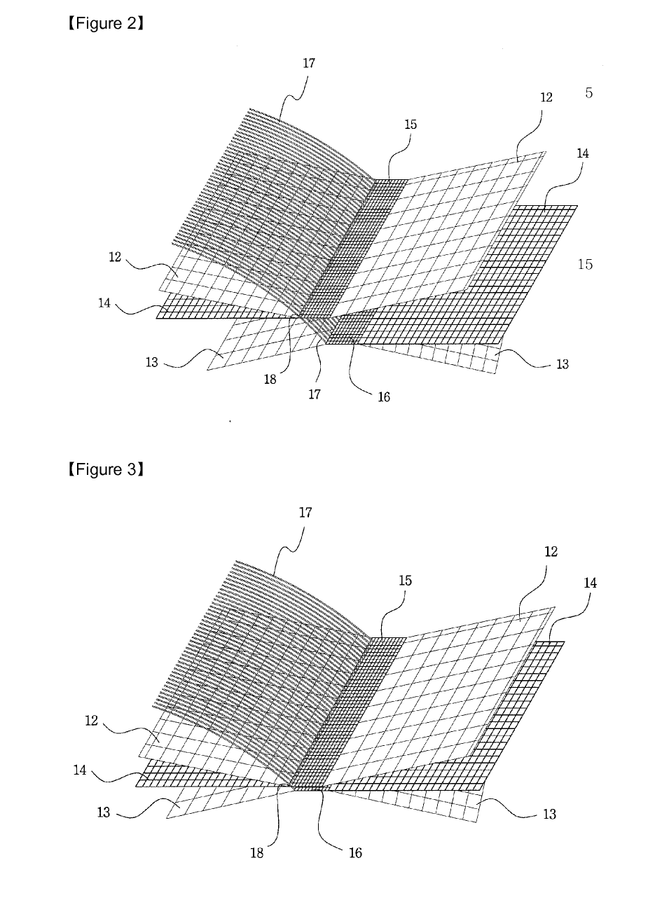

The front textile 12 and the back textile 13 for ventilation and light adjustment are first woven by the warps 12a and 13a and a separate woof, and the slat textile 14 capable of blocking lights is sequentially woven by the warp 17 and a separate woof as shown in FIGS. 2 and 3.

The front textile 12, the back textile 13, and the slat textile 14 are woven and united by the warp 17 united with the front uniting part 15 and the back uniting part 16 by weaving, and are united with each other by the front uniting part 15 and the back uniting part 16 in up and down directions.

At this time, the warp 17 is woven passing through weaving holes 18 formed in the front uniting part 15 after the holes are formed in the back uniting part 16 while an end of the warp 17 united with the front uniting part 15 is repeatedly woven by the woof of the back uniting part 16 again.

Subsequently, and an end of the warp 17 united with the front uniting part 15 is repeatedly woven with the woof of the back uniting part 16 again to form the front uniting part 15 and the back uniting part 16, so that the warp 17 is consequently woven with the woof to form the slat textile 14 capable of blocking lights, the front uniting part 15, and the back uniting part 16 as shown in FIGS. 2, 3 and 6. Such a weaving process is repeatedly performed.

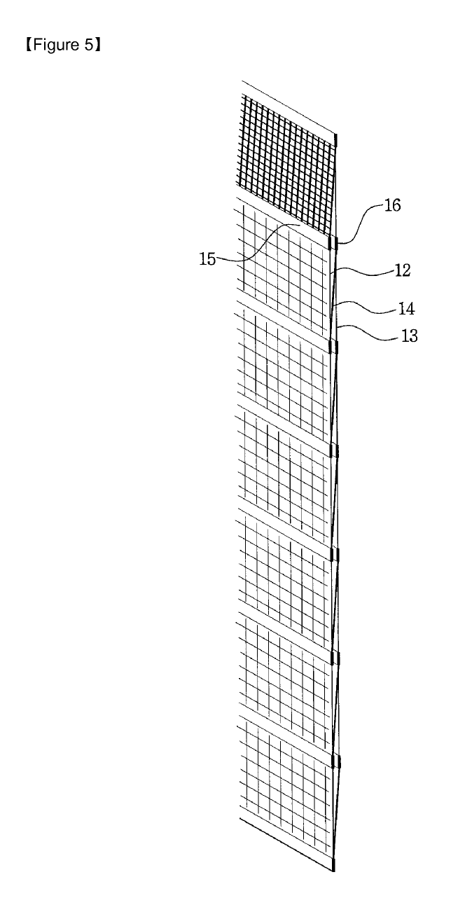

To detail this, a plurality of the slat textiles 14 are arranged along the height direction (i.e., weaving direction) of the front textile 12 and the back textile 13 in the process as described above, the front uniting part 15 of one end formed along the longitudinal direction of the slat textile 14 is disposed in the same position as the back uniting part 16 of the slat textile 14 to be formed next, the slat textile 14 is overlapped with the front uniting part 15 and the back uniting part 16 as shown in FIGS. 3 and 5 when the textile blind 10 is in a plane state, so that the slat textile 14 has an area almost equal to the area of the front textile 12 or the back textile 13 on the whole, thereby blocking lights.

Preferably, the slat textile 14 for the textile blind 10 has a width of 30 to 70 mm to minimize hanging-down of the slat textile 14 and improve an aesthetic sense.

In other words, warps 12a, 13a, 17 of the textile blind 10 are united with respective woofs by weaving to form the front textile 12, the back textile 13, and the slat textile 14 as one body, and the front textile 12, the back textile 13, and the slat textile 14 are woven by the warp 17 united with the front uniting part 15 and the back uniting part 16 by weaving, and the warp 17 is united with the respective woofs by weaving to allow the front textile 12, the back textile 13, and the slat textile 14 to be united with each other in up and down directions.

At this time, the warp 17 is woven passing through weaving holes 18 formed in the front uniting part 15 after the holes are formed in the back uniting part 16 while an end of the warp 17 united with the front uniting part 15 is repeatedly woven by the woof of the back uniting part 16 again, thereby configuring the textile blind 10 united by weaving as shown in FIG. 4 on the whole.

In other words, the front textile 12 and the back textile 13 are woven with separate warps 12a and 13a and the respective woofs, the slat textile 14 is woven with the warp 17 and a separate woof, and the front uniting part 15 and the back uniting part 16 are woven with the warp 17 and a separate woof.

Accordingly, the textile blind 10 having the shape as shown in FIG. 4 can be formed, and the warp 17 is exposed to an external side. When the warp 17 exposed in the front uniting part 15, that is, the portion A denoted in FIG. 4 is cut based on the front uniting part 15 or the back uniting part 16 after it is completely united by weaving, the textile blind 10 is configured as shown in FIG. 5.

Meanwhile, the front textile 12 and the back textile 13 have a mesh structure to facilitate ventilation, and the slat textile 14 has a mesh structure to allow external sights to be viewed while lights are not blocked. As such, each of the warps 12a, 13a, 17 for weaving the front textile 12, the back textile 13, the slat textile 14, the front uniting part 15, and the back uniting part 16 is composed of a synthetic fiber, and has a thickness of 50 to 150 D (denier).

The woof for weaving the front textile 12 and the back textile 13 is composed of a low melt fiber, and has a thickness of 50 to 150 D.

In addition, the woof for weaving the slat textile 14 is composed of two threads, that is, a synthetic fiber and a low melt fiber, and the synthetic fiber has a thickness of 270 to 350 D and the low melt fiber has a thickness of 50 to 150 D.

The woof for weaving the front uniting part 15 and the back uniting part 16 is composed of two threads, that is, a synthetic fiber and a low melt fiber, and the synthetic fiber has a thickness of 280 to 350 D and the low melt fiber has a thickness of 50 to 150 D.

Thickness and material of warps 12a, 13a, 17 and woofs of the textile blind 10 as described above are represented in the table 1 below.

TABLE 1

| Name(No.) | Name(No.) | Material | Thickness(D) | Note |
|---|---|---|---|---|
| front textile | warp(12a) | synthetic fiber | 50~150 | |
| (12) | woof | low melt fiber | 50~150 | |
| back textile | warp(13a) | synthetic fiber | 50~150 | |
| (13) | woof | low melt fiber | 50~150 | |
| slat textile | warp(17) | synthetic fiber | 50~150 | |
| (14) | woof | synthetic fiber | 270~350 | composed |
| | | low melt fiber | 50~150 | of two threads |
| front uniting | warp(17) | synthetic fiber | 50~150 | |
| part | woof | synthetic fiber | 280~350 | composed |
| (15) | | low melt fiber | 50~150 | of two threads |
| back uniting | warp(17) | synthetic fiber | 50~150 | |
| part | woof | synthetic fiber | 280~350 | composed |
| (16) | | low melt fiber | 50~150 | of two threads |

For reference, the low melt fiber used as the woof of the front textile 12, the back textile 13, the slat textile 14, the front uniting part 15, and the back uniting part 16 is made of a low melt fiber having a melting point of 170 to 220° C. This is because that the low melt fiber is bonded with the warps 12a, 13a, 17 such as a synthetic fiber at its melting point due to its characteristic to maintain the respective woven structures, and is not deformed even when an external force is applied, so that the textile blind 10 woven as described above is fixed to maintain its shape by means of melting bond when heat of 170 to 220° C. is applied thereto by a separate Tenter.

In addition, the woof for weaving the front textile 12, the back textile 13, the front uniting part 15, and the back uniting part 16 is mixed (covered) with a rubber thread to prevent folds from occurring after the textile blind is manufactured.

In addition, the textile blind 10 undergoes a flame-retardant treatment so that it is safe against fire. To this end, threads used for the warps 12a, 13a, 17 and the woof of the front textile 12, the back textile 13, the slat textile 14, the front uniting part 15, and the back uniting part 16 undergo a flame-retardant treatment, or have a property safe against fire configured such that the textile blind is put into a flame-retardant liquid before the woven textile blind 10 is processed by the Tenter.

The front textile 12 and the back textile 13 preferably have a mesh structure, and spaces generated by the mesh structure of the front textile 12 and the back textile 13, instead of having all square shapes, have square holes generated by the mesh structure of one of the front textile 12 and the back textile 13, and holes generated by the mesh structure of the other of the front textile 12 and the back textile 13 with a ratio of 1 by 1.5 to 2.5, thereby preventing a moire phenomenon.

Consequently, when the textile blind 10 is completely woven by the warps 12a, 13a, 17 and the woof as shown in FIG. 4, the warp 17 is externally opened to allow the front textile 12 and the back textile 13 to face each other and to allow the textiles 14 therebetween to be successively formed in up and down directions, and then heat generating from a Tenter is applied to the textile blind 10 to be fixed by means of melting bond, and simultaneously both ends of the textile blind 10 are cut and finished, the protruded wrap 17 is removed, and the textile blind 10 configured to have the desired length and width again is applied to the conventional blind structure, which is typically used in the same way as the related art as shown in FIGS. 7 to 9.

Accordingly, the textile blind 10 formed as described above is assembled with a separate blind cover 30, and a support 11 matching the width of the slat textile 14 is fixed at a lower position of the textile blind 10 to prevent shaking after the textile blind 10 is mounted as shown in FIG. 7.

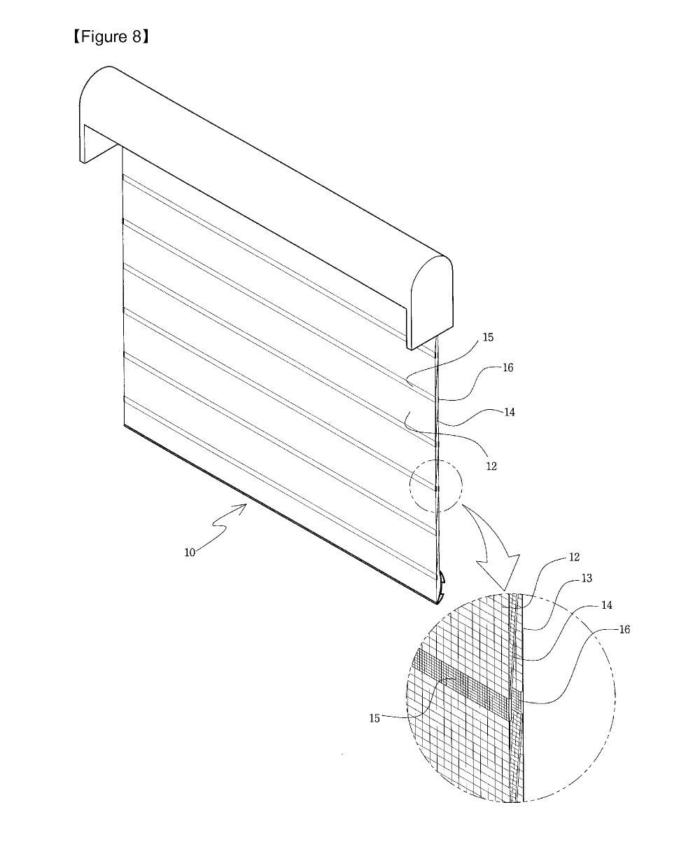

In this case, when the slat textile is raised as shown in FIG. 8, that is, when the slat textile 14 maintains a vertical state with the bottom, the slat textile 14 is in close contact with the front textile 12 and the back textile 13 to block external lights.

In addition, when the slat textile 14 is raised as shown in FIG. 8, the textile blind 10 maintains a plane state, so that the textile blind 10 can be rolled up or out as shown in FIG. 7.

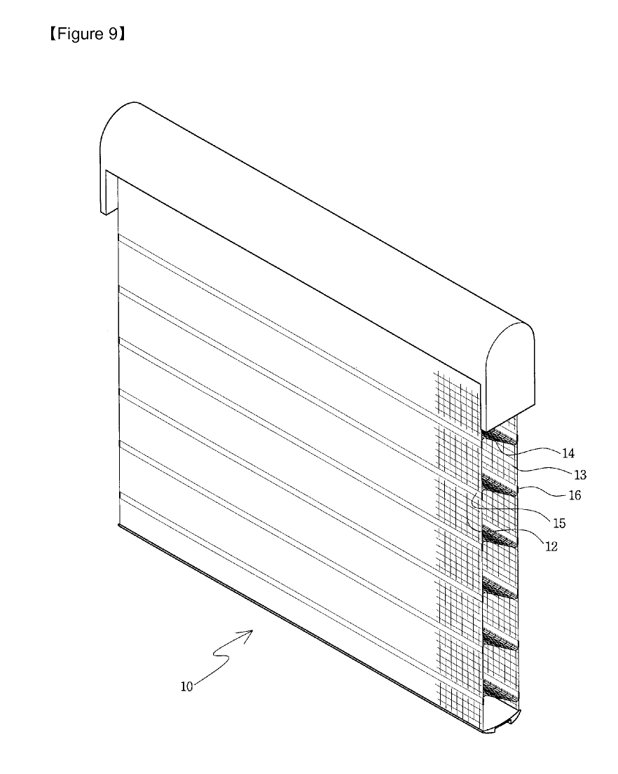

When the slat textile 14 is pulled down as shown in FIG. 9, that is, when the slat textile 14 is pulled down until a horizontal state is maintained on the upper side of the slat textile 14 between the front textile 12 and the back textile 13, the front textile 12 and the back textile 13 become apart from each other, so that a ventilation structure can be generated to allow external airs to circulate through a mesh structure of the front textile 12 and the back textile 13, external sights can be viewed through the mesh structure, and lights can be taken in.

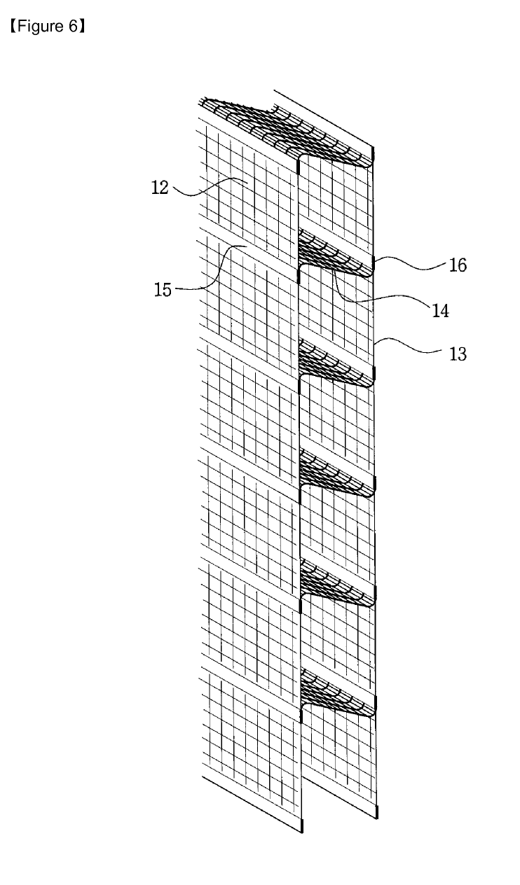

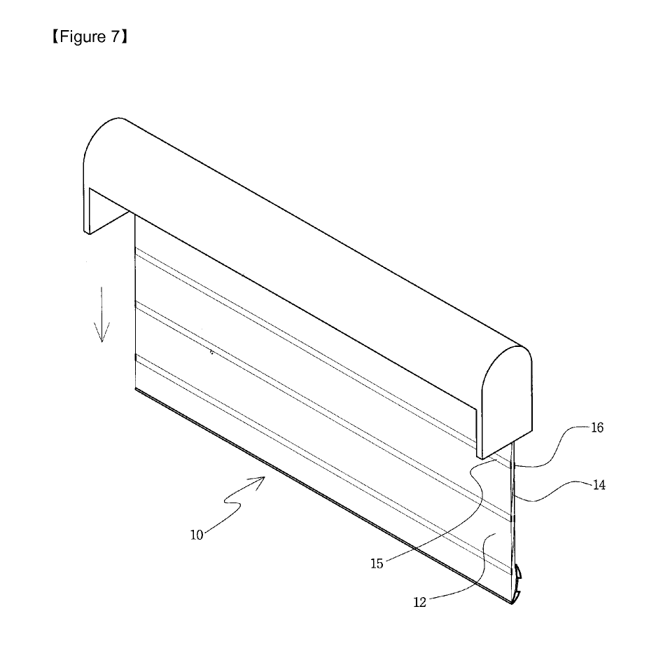

For reference, when the textile blind 10 maintains lighting, the slat textile 14 between the front textile 12 and the back textile 13, instead of having a completely vertical shape, has an arc shape in the position near the front uniting part 15 and the back uniting part 16 when seen in a side view as shown in FIG. 6.

According to the present invention as described above, front and back textiles for ventilation and a slat textile for blocking lights can be simultaneously woven to form a textile blind 10 having several slat textiles 14.

### INDUSTRIAL APPLICABILITY

Such a textile blind can be united by a weaving machine using the above-described method, and can be manufactured and supplied to allow consumers to easily install and use the textile blind.

1-9. (canceled)

10. A woven textile blind comprising
a) a woven front textile comprising a plurality of woven front uniting parts,
b) a woven back textile extending substantially parallel to the front textile and comprising a plurality of woven back uniting parts, wherein each of said front uniting parts has a corresponding back uniting part that extends parallel thereto, and
c) a plurality of woven slat textiles connecting the front textile to the back textile, wherein each of said slat textiles has a front edge and a back edge and is woven along its front edge into a front uniting part and is woven along its back edge into a back uniting part that corresponds to said front uniting part, wherein a part of a warp of said slat textiles passes through a weaving hole formed in the front textile or the front uniting parts and is exposed on an external side of the front textile.

11. The textile blind according to claim 10, wherein the front uniting part of one slat textile has the same height as the back uniting part of an adjacent slat textile when the blind is in a planar state.

12. The textile blind according to claim 10, wherein each of the front and back textiles has a mesh structure to facilitate lighting and ventilation.

13. The textile blind according to claim 12, wherein each mesh of one of the front and back textiles has a square shape and each mesh of the other of the front and back textiles has a shape with a ratio of 1 by 1.5 to 2.5 to prevent a moiré phenomenon.

14. The textile blind according to claim 10, wherein a warp for weaving the front textile, back textile, slat textile, front uniting part, and back uniting part is composed of a synthetic fiber having a thickness of 50 to 150 Denier, a woof for weaving the front textile and the back textile is composed of a low melt fiber having a thickness of 50 to 150 Denier, a woof for weaving the slat textile is composed of a low melt fiber having a thickness of 50 to 150 Denier and a synthetic fiber having a thickness of 280 to 350 Denier, and a woof for weaving the front and back uniting parts is composed of a low melt fiber having a thickness of 50 to 150 Denier and a synthetic fiber having a thickness of 280 to 350 Denier, so that the structure of the textile blind can be easily maintained.

15. The textile blind according to claim 14, wherein the low melt fiber has a melting point of 170 to 220 degrees Celsius to facilitate maintaining of the structure through weaving of the textile blind and a Tenter.

16. The textile blind according to claim 10, wherein the textile blind undergoes a flame-retardant treatment so that the textile blind is safe against fire.

17. The textile blind according to claim 10, wherein the slat textile has a width of 30 to 70 millimeters to minimize hanging-down of the slat textile.

18. The textile blind according to claim 10, wherein a woof for weaving the front and back textiles and the front and back uniting parts is mixed with a rubber thread to prevent folds of the textile blind from occurring.

19. The textile blind according to claim 11, wherein the slat textile has a width of 30 to 70 millimeters to minimize hanging-down of the slat textile.

20. The textile blind according to claim 12, wherein the slat textile has a width of 30 to 70 millimeters to minimize hanging-down of the slat textile.

21. The textile blind according to claim 13, wherein the slat textile has a width of 30 to 70 millimeters to minimize hanging-down of the slat textile.

22. The textile blind according to claim 14, wherein the slat textile has a width of 30 to 70 millimeters to minimize hanging-down of the slat textile.

23. The textile blind according to claim 15, wherein the slat textile has a width of 30 to 70 millimeters to minimize hanging-down of the slat textile.

24. The textile blind according to claim 16, wherein the slat textile has a width of 30 to 70 millimeters to minimize hanging-down of the slat textile.

25. The textile blind according to claim 11, wherein a woof for weaving the front and back textiles and the front and back uniting parts is mixed with a rubber thread to prevent folds of the textile blind from occurring.

26. The textile blind according to claim 12, wherein a woof for weaving the front and back textiles and the front and back uniting parts is mixed with a rubber thread to prevent folds of the textile blind from occurring.

27. The textile blind according to claim 13, wherein a woof for weaving the front and back textiles and the front and back uniting parts is mixed with a rubber thread to prevent folds of the textile blind from occurring.

28. The textile blind according to claim 14, wherein the woof for weaving the front and back textiles and the front and back uniting parts is mixed with a rubber thread to prevent folds of the textile blind from occurring.

29. The textile blind according to claim 16, wherein the woof for weaving the front and back textiles and the front and back uniting parts is mixed with a rubber thread to prevent folds of the textile blind from occurring.

30. A method of manufacturing woven textile fabric shade comprising a front textile, a back textile parallelly positioned to the front textile, and a plurality of slat textiles having a predetermined width along a width between the front and back textiles and being positioned therebetween, comprising at least the steps of:
a) uniting the front textile and the slat textiles by weaving the warp of the front textile and the warp of the slat textiles with common woof at least in the section of the front uniting part;
b) uniting the slat textiles and the back textile by weaving the warp of the slat textiles and the warp of the back textile with common woof at least in the section of the back uniting part;
c) shifting some warp from the position of back textile to the position of front textile in order to use it for weaving other slat textiles to be woven in the future; and
d) cutting or removing the shifted warp above at the shifted section.

31. The method as set forth in claim 30, wherein the shifted warp passes through weaving holes formed in the front uniting part.

32. The method as set forth in claim 30, wherein the shifted warp is emerged from the back uniting part.

33. The method as set forth in claim 31, wherein the shifted warp is emerged from the back uniting part.

34. The method as set forth in claim 30, wherein the end of the shifted warp is woven at least at the next front uniting part with the warp of the front textile by common woof.

35. The method as set forth in claim 31, wherein the end of the warp which has passed through the weaving hole is woven at the next front uniting part with the warp of the front textile by common woof.

36. The method as set forth in claim 30, wherein warp emerged from the front uniting part after being woven at the front uniting part is woven by the separate woof of the slat textile.

37. The method as set forth in claim 31, wherein warp emerged from the front uniting part after being woven at the front uniting part is woven by the separate woof of the slat textile.

38. The method as set forth in claim 32, wherein warp emerged from the front uniting part after being woven at the front uniting part is woven by the separate woof of the slat textile.

39. The method as set forth in claim 33, wherein warp emerged from the front uniting part after being woven at the front uniting part is woven by the separate woof of the slat textile.

40. The method as set forth in claim 34, wherein warp emerged from the front uniting part after being woven at the front uniting part is woven by the separate woof of the slat textile.

41. The method as set forth in claim 35, wherein warp emerged from the front uniting part after being woven at the front uniting part is woven by the separate woof of the slat textile.

42. The method as set forth in claim 30, wherein the front textile and the back textile for ventilation and lighting are woven by the warps of the front textile and the back textile and separate woofs respectively.

43. The method as set forth in claim 36, wherein the front textile and the back textile for ventilation and lighting are woven by the warps of the front textile and the back textile and separate woofs respectively.

44. A woven textile blind, comprising;
a front textile 12 woven by a warps 12a with a woof;
a back textile 13 woven by a warps 13a with a separate woof and parallelly positioned to the front textile 12;
a slat textile 14 woven by a warps 17 with another separate woof between the front textile 12 and the back textile 13;
a front uniting part 15 woven by the warps 12a of the front textile 12 and the warps 17 of the slat textile 14 with a woof; and
a back uniting part 16 woven by the warps 13a of the back textile 13 and the warps 17 of the slat textile 14 with a woof;
wherein the front textile 12 and the slat textile 14 are united at the front uniting part 15, and the back textile 12 and the slat textile 14 are united at the back uniting part 15, and the warp 17 is woven with the warp 13a of the back textile 13 at the back uniting part 16, passes through a weaving hole 18 formed in the front textile 12 or the front uniting part 15, is woven with the warp 12a of the front textile 12 at the front uniting part 15, is woven with a separate woof of the slat textile 14, and is woven with the warps 13a of the back textile 13 at the back uniting part 16.
